(19) United States
(12) Patent Application Publication
(10) Pub. No.: US 2025/0150300 A1
(43) Pub. Date: May 8, 2025

(54) TECHNIQUES FOR ADJUSTING NETWORK-CONNECTED DEVICE FUNCTIONALITY BASED ON STATES

(71) Applicant: Apple Inc., Cupertino, CA (US)

(72) Inventors: Jeffery T. Lee, Los Gatos, CA (US); Toshiro Yamada, San Francisco, CA (US); Kuldeep R. Modi, San Jose, CA (US)

(73) Assignee: Apple Inc., Cupertino, CA (US)

(21) Appl. No.: 18/933,456

(22) Filed: Oct. 31, 2024

Related U.S. Application Data
(60) Provisional application No. 63/547,293, filed on Nov. 3, 2023.

(51) Int. Cl. H04L 12/28

(52) U.S. Cl. CPC H04L 12/2827; H04L 12/282

(57) ABSTRACT

A first status signal can be received by a controller device from a first user proxy device. The first status signal can indicate whether the first user proxy device is within a threshold distance from a location. The location can be associated with a state and one or more devices. Settings on the one or more devices can be based on the state. The state can be determined from a hierarchy of potential states. Determining the state from a hierarchy of potential states can be based on satisfying a criteria of a parent state of the hierarchy. Determining the state can be further based on satisfying a second criteria of a child state of the parent state.

### CROSS-REFERENCES TO RELATED APPLICATIONS

This application claims the benefit of U.S. Provisional Application No. 63/547,293, filed on Nov. 3, 2023, which is incorporated by reference.

### TECHNICAL FIELD

The disclosure generally relates to interactions between accessory devices and computing devices that are connected on a local network.

### BACKGROUND

Home automation is becoming more and more popular. Starting with automatic clothes and dish washing machines years ago to the smart (e.g., network-connected and controllable) fixtures, appliances, and accessories of today, more and more people are automating their homes. With the increasing availability of smart accessories and appliances comes more ways to control these smart devices. For example, a software application on a user's mobile device can be configured to control individual accessories, appliances, and/or fixtures in the user's home or office.

### SUMMARY

A system of one or more computers can be configured to perform particular operations or actions during specific instances by virtue of having software, firmware, hardware, or a combination of them installed on the system, which in operation can cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method can include receiving, by a controller device and from a first user proxy device, a first status signal that indicates whether the first user proxy device is associated with a state determined from a hierarchy of potential states. The controller device can be configured to send instructions to the one or more devices to enable settings on the one or more devices based at least in part on the state. The computer-implemented method can also include determining, by the controller device, the state from the hierarchy of potential states. Determining, by the controller device, the state from the hierarchy of potential states can also include determining, by the controller device, that a criteria for a parent state of the hierarchy of potential states is satisfied based at least in part on the first status signal, the parent state being associated with a child state. Determining, by the controller device, the state from the hierarchy of potential states can also include receiving, by the controller device, a second status signal. Determining, by the controller device, the state from the hierarchy of potential states can also include determining, by the controller device, whether a second criteria for the child state is satisfied based at least in part on the second status signal. Determining, by the controller device, the state from the hierarchy of potential states can also include in accordance with a determination that the second criteria is not satisfied, determining, by the controller device, that the state corresponds to the parent state. Determining, by the controller device, the state from the hierarchy of potential states can also include in accordance with a determination that the second criteria is satisfied, determining, by the controller device, that the state corresponds to the child state. The computer-implemented method can also include determining, by the controller device, the settings for the one or more devices based at least in part on the state. The computer-implemented method can also include transmitting, by the controller device to the one or more devices, instructions to enable the settings on the one or more devices.

### DESCRIPTION OF DRAWINGS

FIG. 1 shows an example home environment.

FIG. 2 shows an example network configuration.

FIG. 3 is a block diagram of an example system for determining a state.

FIG. 4 is a block diagram of an example hierarchy of states and example relevant signals for determining a state.

FIG. 5 is an illustration of an example house having various smart devices.

FIG. 6 is a flow diagram of an example process for implementing the techniques described herein.

FIG. 7 shows a simplified block diagram of an example system architecture for a controller.

FIG. 8 shows a simplified block diagram of an example system architecture for an accessory.

### DETAILED DESCRIPTION

Certain embodiments of the present disclosure relate to devices, computer-readable medium, and methods for implementing various techniques for various features of adjusting network-connected device functionality based on states. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media for controlling smart devices. Home automation includes smart devices in homes which are connected to a network for remote access and control. Smart devices can be referred to as network-connected devices. Smart devices can include controllers and accessories (for example, lamps, lights, fans, heating, ventilation, and cooling (HVAC) systems, etc.). Controllers can be any device that is capable of sending a control instruction to a controllable device. Controllers can include resident devices (for example, smart speakers, smart televisions, etc., that may not regularly be moved) and mobile devices (for example, smart phones, tablets, laptops, etc.). Some devices can be both resident devices and mobile devices (for example, tablets and laptops).

A user can control smart devices both by directly interacting with a smart device's user interface (whether a graphical user interface on a screen or through other interface elements such as buttons), or through use of a controller. An accessory can be any device that is capable of receiving a control instruction (for example, from a controller) and acting based on the instruction (e.g., changing its internal settings). Controllers can also receive a control instruction in some situations and act based on the instruction. A user can generate service groups of related smart devices (e.g., groups of related smart devices and/or groups of smart devices to be controlled together) and control smart devices and service groups by generating settings for common scenarios (also referred to as states or location states) as described herein.

Users can control the functionality of their smart devices through the use of settings. Users can enable certain settings on their smart devices to enable different types of functionality. For example, a user may want to set the temperature in the house (or a room in the house) to a specific temperature while the user (or someone else who lives in the house) is at home. In another example, a user may want to have air conditioning turn on in a particular room of the house when the temperature in that particular room exceeds a threshold. In a further example, a user may want security cameras inside and/or outside the home to turn on when the user leaves the home. However, the user may want the security cameras inside the home to turn off while the user is at home. Furthermore, the user may want the security cameras in certain parts of the home to turn on while the user is asleep.

Although examples are related to smart devices in a home, any collection of smart devices at any number of locations can be controlled as described herein. In this way, a “home state” can be seen as a “group state” that defines the group of smart devices regardless of location of the smart devices.

Sets of settings for the smart devices in the home can be controlled via the use of a home state coordinated by a controller (for example, a resident device such as a smart speaker or smart television). Various home states can be created by a user with specific settings for the smart devices in the home. The controller can determine the home state and send instructions to the devices in the home to enable settings associated with the home state. For example, a user may create a “home” (or “at-home”) state for the smart devices in the user's home for when the user is at home. Similarly, a user may create an “away” state for the smart devices in the user's home for when the user is not at home.

However, automatically determining the home state (such as the “home” and “away” states) and thus when to apply these different sets of settings can be difficult. Signals from a specific user device associated with the user (referred to as the user proxy device) and various signals from the devices in the home can be used to determine the home state. In particular, the user proxy device and at least some of the devices in the homes can include software detectors that detect and determine when particular events occur. The user proxy device and the smart devices located in the home can generate status signals regarding these particular events and send them to the controller. The controller can aggregate the status signals to determine the home state.

However, there may be many status signals that the controller may receive to determine the home state. In order to simplify the determination of the home state, a hierarchy of potential states can be established. In this way, the determination of the home state can include multiple stages of determination. For example, when determining the home state, a first stage can include a determination if the user is at home or away from home. If the user is determined to be at home, a second stage can include a determination if the user is going to sleep, if the user is asleep, if the user is waking up, or if the user is leaving home soon. Each of these determinations can be associated with a different home state (for example, a “going-to-sleep” state, a “sleep” state, a “waking-up” state, and a “leaving-home” state). In some situations, none of the determinations of the second stage are true and the home state remains in the “at-home” state. The “at-home” state can be referred to as a parent state of the “sleep” state and other previously described states. Furthermore, the hierarchy of potential states can be used to simplify properties related to the home state. For example, when a home state is in the “sleep” state, the “sleep” state is a child of the “at-home” state which relates the property that the user is at home.

Furthermore, the hierarchy of potential states can be used to create transitional states. Transitional states can be home states that are temporary in nature, such that the home state will change to another home state once a criteria is met or when a timer expires.

For example, the home state can be in the “away” state, but an indication received at the user proxy device can indicate that the user is returning home. This can cause the controller to determine that the home state should change to a “returning-home” state. The “returning-home” state can be a transitional state such that the user returns home prior to the expiration of a timer such that the home state changes to the “at-home” state, or the timer expires and the home state changes back to the “away” state. The use of transitional states can be used to return the home state to a more preferable state. For example, a “returning-home” state may bring cause the HVAC system in the home to lower the maximum temperature and raise the minimum temperature in the home such that the home is not too hot or too cold when the user arrives at home. However, if the user does not arrive at home before the timer expires, then the HVAC system can return to a wider temperature range to limit energy consumption.

Additionally, each potential home state can have an authenticated version and an unauthenticated version. An authenticated version of a home state and an unauthenticated version of a home state can enable different settings on different smart devices. The unauthenticated version of a home state can be used when the controller determines that the status signals reach and/or exceed a minimum threshold to enable a change in state. The authenticated version of a home state can be used when the controller determines that the status signals reach and/or exceed a second higher threshold to enable a change in the state. In some examples, sensors in the home may indicate that a person is at-home, for example motion detectors may detect motion in the home. The sensors may indicate that the motion is above a minimum threshold such that there is sufficient indication that someone is at home (for example, a child or a burglar), but the sensors are unable to determine if the user is at home. The home state can change to an unauthenticated version of the home state which may leave internal cameras to the home on, whereas the internal cameras turn off in the authenticated version of the home state. Other sensors (for example, cameras combined with facial recognition) may determine that a known person (such as the user or a family member) such that the determination can be made to enter an authenticated version of the “at-home” state.

Home states can also be referred to as location states. The examples contained herein may pertain to residential homes and/or residential houses, but the use of home states can be used in any type of building, portion of a building, particular rooms of a building, and/or other types of locations. In this way, the concept of home states can be applied to myriad locations.

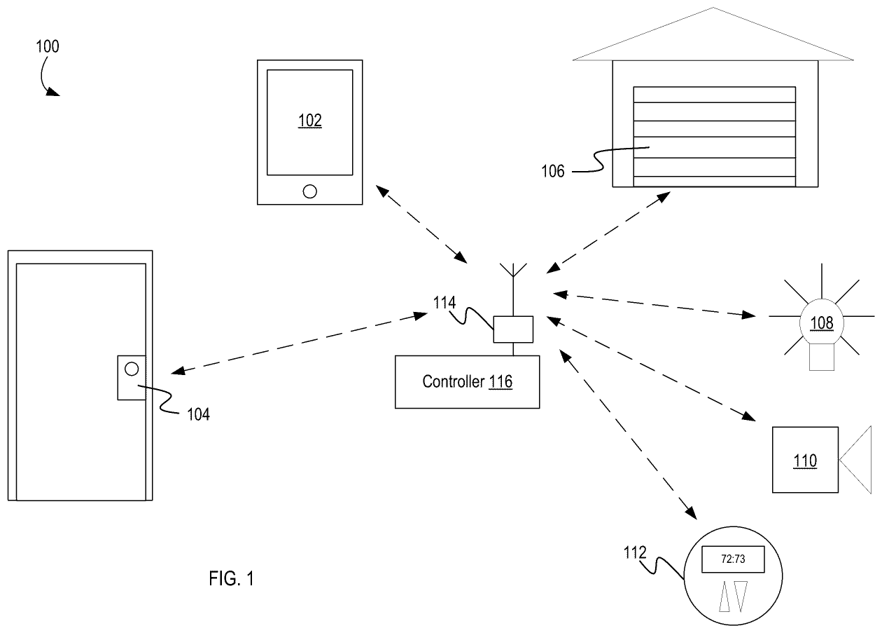

FIG. 1 shows an example home environment 100. Home environment 100 includes a setup device 102 that can be used to setup smart devices (for example, mobile devices, resident devices, and accessories) located in the environment and configure a hierarchy of home states. Setup device 102 can include, for example, a desktop computer, laptop computer, tablet computer, smart phone, wearable computing device, personal digital assistant, a smart router, a smart wireless access point, or any other computing device or set of devices that is capable of communicating setup instructions for the hierarchy of potential home states to a controller 116 and presenting a user interface to allow a user to indicate desired operations on the accessories.

The setup device 102 can also establish the hierarchy of potential home states to be used in the home environment. Through the user interface of the setup device 102, the user can use pre-specified home states (for example, “at-home” and “away” home states) and create custom home states. The user can also determine settings for smart devices in the home in each of the home states.

In some examples, the controller 116 can maintain a hierarchy of potential states that are not necessarily related to a single location or home. For example, the controller 116 can maintain a hierarchy of potential states for a group of smart devices irrespective of the locations of the smart devices. For example, the controller 116 can maintain a hierarchy of potential states for a group of smart devices spread across multiple homes, across a home and another area (such as a park or office), or across multiple areas.

The hierarchy of potential home states can be managed by a controller 116. The controller 116 can use signals from the accessories as well as user proxy devices to determine the home state from the hierarchy of potential home states. After determining the home state, the controller 116 can determine settings to enable on the one or more smart devices in the home environment. The controller 116 can send command-and-control messages (for example, instructions) to the smart devices in the home environment to enable the determined settings. In some examples, the controller 116 can determine instructions to enable settings on the one or more smart devices in the home environment.

Any type of smart device can be controlled. Examples of smart devices that are accessories include door lock 104, garage door system 106, light fixture 108, security camera 110, and thermostat 112. In some instances, controller 102 can communicate directly with a smart device; for instance, controller 102 is shown communicating directly with door lock 104 and garage door system 106. In other instances, controller 116 can communicate via an intermediary. For instance, controller 116 is shown communicating via a wireless network access point 114 with smart devices 108, 110, 112 that are on a wireless network provided by access point 114. As noted above, in some embodiments, controller 116 can include a base station, and base station functionality can be integrated into access point 114 or into one of the accessories that is to be controlled (e.g., thermostat 112).

Various communication transports and combinations of transports can be used, and different transports can be used with different devices. For example, some wireless transports such as the Bluetooth® Classic or Bluetooth® Smart communication protocol and standards promulgated by the Bluetooth SIG (referred to herein as “Bluetooth” and “Bluetooth LE”) can support direct point-to-point communication between devices within a limited range. Other wireless transports such as a wireless network complying with Wi-Fi® networking standards and protocols promulgated by the Wi-Fi Alliance (referred to herein as a “Wi-Fi network”) can define a wireless network with a central access point that routes communications between different devices on the network. Further, while wireless communication transports are shown, wired transports can also be provided for some or all of the smart devices. For example, light bulb 108 can be connected to access point 114 by a wired connection, and controller 116 can communicate with light bulb 108 by sending messages wirelessly to access point 114, which can deliver the messages to light bulb 108 via the wired connection.

Further, while one controller 116 is shown, a home environment can have multiple controller devices. For example, multiple devices can serve as a controller for some or all of smart devices 104-112. Different controller devices can be configured to communicate with different subsets of the smart devices; for example, a first controller might be configured to send instructions modifying settings on thermostat 112 but not be configured to send instructions to modify settings for the door lock 104. Instead, a second controller may be configured to send instructions to modify settings for the door lock 104. Having multiple controller devices may be useful to spread the responsibility for sending instructions to accessories. Similarly, multiple controller devices can be useful in case a subset of the controller devices loose network connection or power such that the subset of controller devices cannot communicate with accessories. In this case, other controller devices can take responsibility for the accessories.

In some embodiments, a uniform accessory protocol can facilitate communication by a controller 116 with one or more smart devices 104-112. The protocol can provide a simple and extensible framework that models a smart device as a collection of services, with each service being defined as a set of characteristics, each of which has a defined value at any given time. Various characteristics can represent various aspects of the smart device's state. For example, in the case of thermostat 112, characteristics can include power (on or off), current temperature, and target temperature. In some embodiments, message formats may be transport-dependent while conforming to the same smart device model.

The protocol can further define message formats for controller 116 to send command-and-control messages (requests) to accessory 112 (or other smart devices) and for accessory 112 to send response messages to controller 116. The command-and-control messages can allow controller 116 to interrogate the current state of smart device characteristics and in some instances to modify the characteristics (e.g., modifying the power characteristic can turn a smart device off or on). Accordingly, any type of smart device, regardless of function or manufacturer, can be controlled by sending appropriate messages. The format can be the same across smart devices.

The protocol can further provide notification mechanisms that allow accessory 112 (or other smart devices) to selectively notify controller 116 in the event of a state change. Multiple mechanisms can be implemented, and controller 116 can register, or subscribe, for the most appropriate notification mechanism for a given purpose.

It will be appreciated that home environment 100 is illustrative and that variations and modifications are possible. Embodiments described herein can be implemented in any environment where a user wishes to control one or more smart devices using a controller device, including but not limited to homes, cars or other vehicles, office buildings, campuses having multiple buildings (e.g., a university or corporate campus), etc. Any type of smart device can be controlled, including but not limited to door locks, door openers, lighting fixtures or lighting systems, switches, power outlets, cameras, environmental control systems (e.g., thermostats and HVAC systems), kitchen appliances (e.g., refrigerator, microwave, stove, dishwasher), other household appliances (e.g., clothes washer, clothes dryer, vacuum cleaner), entertainment systems (e.g., TV, stereo system), windows, window shades, security systems (e.g., alarms), sensor systems, and so on. A single controller can establish pairings with any number of smart devices and can selectively communicate with different smart devices at different times. Similarly, a single smart device can be controlled by multiple controllers with which it has established pairings. Any function of a smart device can be controlled by modeling the function as a service having one or more characteristics and allowing a controller to interact with (e.g., read, modify, receive notifications of updates to) the service and/or its characteristics. Accordingly, protocols and communication processes used in embodiments of the technology described herein can be uniformly applied in any context with one or more controllers and one or more accessories, regardless of smart device function or controller form factor or specific interfaces.

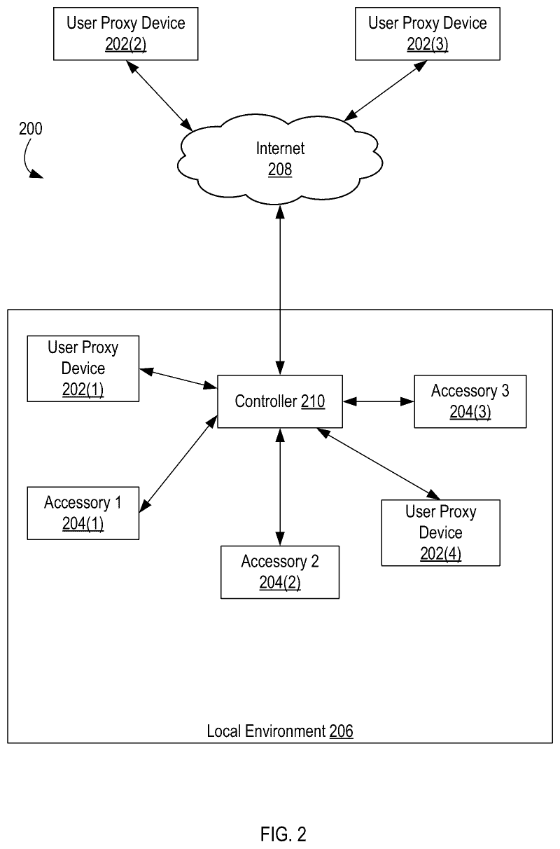

FIG. 2 shows an example network configuration 200. Once a setup device (for example, the setup device 102 of FIG. 1) has specified the hierarchy of potential home states and the settings for the various smart devices for each of the potential home states, the controller 210 can receive status signals from the various smart devices to determine the home state. Configuration 200 can include user proxy devices 202 which can determine the occurrence of events and send status signals to the controller 210. User proxy devices 202 can be specifically designated devices that are used as a proxy for the user. Each user associated with the home can be designated a user proxy device 202. User proxy devices 202 serve as a proxy for an associated user and can send signals to the controller 210 used to determine the home state. An example user proxy device can be a phone. In some examples, each user has exactly one single user proxy device. For example, if a first user has two phones, a tablet, and a laptop, only one of the phones can be designated as the user proxy device for the first user. User proxy devices 202 can be used to receive signals from a user. For example, a location of a user proxy device 202 can be used as a location of the associated user. Similarly, when a particular status of a user proxy device 202 is activated, the particular status can be associated with the status of the associated user. For example, if the user proxy device 202 is in a “vacation” status, then the status of the associated user can be a “vacation status.” In some examples, the same device that is designated as a user proxy devices 202 can be a setup device (for example, the setup device 102 of FIG. 1).

Accessories 204 (for example, the various accessories shown in FIG. 1) can each communicate with the controller 210 that can be located with local environment 206. In some examples, accessories 204 can include other user devices that are not user proxy devices 202. For example, a phone, laptop, tablet, or other device can be a user device that is designated as an accessory (even if the user device is mobile and can leave the home), but not a user proxy device 202. Controller 210 can include any device that is capable of presenting itself as a controller to accessories 204. In some embodiments, controller 210 can be a device that is expected to stay in local environment 206 and that is expected to be powered on and available for communication most or all the time. In this way, controller 210 can be referred to as a resident device that resides in the home. (It is to be understood that controller 210 can occasionally be unavailable, e.g., in connection with software or firmware upgrades, power outages, or other intermittent occurrences.) For example, controller 210 can be implemented in a desktop computer, a Wi-Fi or access-point unit, a smart speaker, a dedicated smart device-control base station, a set-top box for a television or other appliance (which can implement controller functionality in addition to interacting with the television or other appliance), or any other electronic device as desired.

The controller 210 can receive status signals from at least some of the user proxy devices 202 and at least some of the accessories 204 to determine the home state. The controller 210 can send instructions to enable settings on the accessories 204 based on the home state. In some examples, the controller 210 can send instructions to enable settings on the user proxy devices 202.

In some embodiments, controller 210 and accessories 204 can communicate using a local area network (LAN), such as a Wi-Fi network and/or a point-to-point communication medium such as Bluetooth LE. It is to be understood that other communication protocols can be used. In some embodiments, user proxy devices 202, accessories 204, and controller 210 can support a uniform smart device protocol as described above that can be supported using both Wi-Fi and Bluetooth LE as transports.

In the example of FIG. 2, user proxy devices 202(1) and 202(4) are currently located in local environment 206 with accessories 204 and controller 210. For example, user proxy device 202(1) can be on the same LAN as accessories 204 and controller 210. User proxy devices 202(2) and 202(3) are currently located outside local environment 206 but are connected to a communication network 208 (e.g., the Internet); such controllers are said to be “remote” from accessories 204 and controller 210. It is to be understood that user proxy devices 202 can be mobile devices that are sometimes within local environment 206 and sometimes outside local environment 206. Accessories 204 need not be mobile and need not be connected to communication network 208 (although they can be if desired).

It will be appreciated that network configuration 200 is illustrative and that variations and modifications are possible. Any number of controllers and any number of accessories can be included in a network configuration.

As noted above, controller 210 can be particularly useful in the context of an automated environment with a number of smart devices that can be controlled. Examples include homes, cars or other vehicles, office buildings, campuses having multiple buildings, etc. For purposes of illustration, an example of a smart device network implementation for a home will be described; those skilled in the art with access to the present disclosure will understand that similar smart device networks can be implemented in other automated environments.

In one example of a smart device network, each smart device is connected to one or more controllers, and smart device can be controlled by messages and/or instructions from the one or more controllers. This can be perfectly serviceable for small networks with just a few smart devices. However, in some instances, particularly as the number of smart devices increases, it can be helpful to establish meaningful (to a user) groups of smart devices that can be managed in a coordinated fashion. Accordingly, certain embodiments of the present technologies described herein incorporate environment models usable to coordinate control across multiple smart devices in a smart device network.

As used herein, an environment model can provide various logical groupings of the smart devices in an environment. For example, a home environment can be modeled by defining “rooms” that can represent rooms in the home (e.g., kitchen, living room, master bedroom, etc.). In some cases, a room in the model need not correspond to a room in the home; for instance, there can be a “front yard” room or an “anywhere” room (which can be used to refer to smart devices that are present in the home but whose location within the home is subject to change or has not been defined as a room). Each smart device in the home can be assigned to a room in the environment model, e.g., based on the actual physical location of the smart device. Rooms can be grouped into zones based on physical and/or logical similarities. For instance, an environment model for a two-level house might have an “upstairs” zone and a “downstairs” zone. As another example, an environment model might have a “bedrooms” zone that includes all bedrooms regardless of where they are located. The model can be as simple or complex as desired, e.g., depending on the size and complexity of the environment.

Where an environment model is defined, smart devices represented in the environment model can be controlled individually or at the level of rooms, zones, or the whole model. For instance, a user can instruct a controller to turn on all the outside lights or to turn off all smart devices in a specific room.

Other groupings of smart devices can also be defined. For example, in some embodiments, a user can augment an environment model by grouping various smart devices into “service groups” that can include any set of smart devices the user may desire to control together, at least some of the time. A service group can include smart devices in any combination of rooms or zones, and the smart devices in a service group can be homogeneous (e.g., all upstairs lights) or heterogeneous (e.g., a light, a fan, and a TV). In some embodiments, a user can provide a single instruction to a controller to set the state of an entire service group (e.g., turn the group on or off). While not required, the use of service groups can provide another degree of flexibility in coordinating control over multiple smart devices.

In some embodiments, the environment model for a given environment can be represented as a data object (or set of data objects). The environment model can be created on a controller 210 associated with the environment and can be shared with other controllers through a synchronization operation. For instance, controllers can synchronize with a “master” copy of the environment model maintained by a specific controller or cloud-based synchronization (in which the master copy is stored in a location accessible via network 208 and automatically synchronized with the controllers associated with the environment) can be used. Accordingly, all controllers associated with a given environment can have shared access to the same environment model.

In some implementations, controllers can be used to control and interact with other controllers in the same way controllers can be used to control and interact with accessories 204 as described herein.

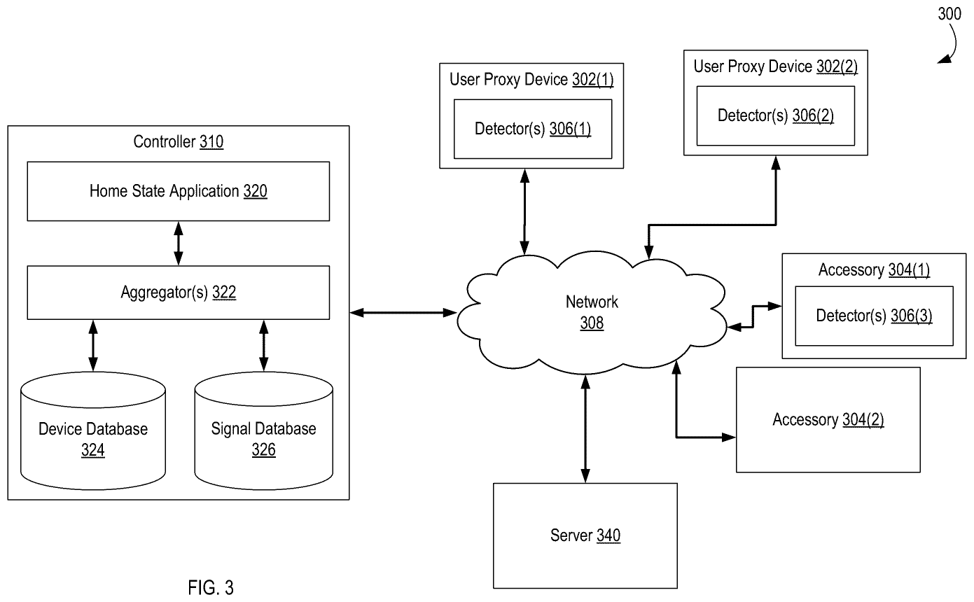

FIG. 3 is a block diagram of an example system 300 for managing smart devices through the use of home states. In some implementations, system 300 can include user proxy device 302(1). User proxy device 302(1) can be associated with a first user, such that the status(es) of user proxy device 302(1) can be associated with the first user. User proxy device 302(2) can be associated with a second user, such that the status(es) of user proxy device 302(2) can be associated with the second user. The first user and the second user can both be associated with the same home. For example, the first user and the second user can be partners that live together. Multiple users can be associated with the same home. For example, other users can be children or other residents of the home. User proxy devices 302(1) and 302(2) can be a computing device, such as a laptop computer, tablet computer, smartphone, or wearable device (e.g., a smartwatch, smart glasses, smart clothing, etc.).

Controller 310 can correspond to controller 210 (e.g., controller 116), as described above with reference to FIG. 2. Controller 310 can be a computing device, such as a desktop computer, streaming media device, home media server, router, or other computing device. In some implementations, controller 310 can include aggregator(s) 322. For example, aggregator(s) 322 can be a daemon or background process running on controller 310 that monitors status signals from various smart devices and/or coordinates communication between smart devices and other user devices (e.g., other home applications), as described herein. For example, aggregator(s) can receive signals from user proxy devices, other user devices, and accessories. In some implementations, aggregator(s) 322 can be configured to collect state information, configuration information, and/or feature information from various smart devices and store the device information in the appropriate databases (e.g., device database 324, signal database 326, etc.). For example, the device database 324 can include information regarding the smart devices in the home such as identifiers and instructions to cause the devices to enable particular settings. Detector(s) 306 on the user proxy devices and accessories 304 can contain logic to determine statuses of specific conditions and/or whether an event has recently occurred. The detector(s) 306 can send the statuses to aggregator(s) of the controller 310. For example, a detector 306 (1) on user proxy device 302(1) can query a location of the user proxy device 302(1), for example, by querying the global positioning system coordinates of the user proxy device 302(1). The detector 306 (1) can determine that the user proxy device 302(1) is more than one hundred meters from the center of the home. Based on this determination, the detector 306 (1) can determine that the user proxy device 302(1) is “away” from home. The detector 306 (1) can convey the status of “away” to an aggregator 322. Aggregator(s) 322 can receive information from detector(s) 306 on the user proxy devices 302 and/or the accessories 304. In some examples, all user proxy devices 302 have at least one detector 306. In some examples, a subset of accessories 304 have at least one detector 306. For example, an accessory 304 that plays music may not have a detector 306 to transmit status signals to an aggregator 322. However, an accessory 304 that is a camera can have one or more detectors that can transmit status signals that indicate a person is in the house and/or the person is recognized as a known person. These status signals can be sent to the aggregator 322.

In some examples, a detector 306 (1) may be prevented from sharing a status signal with or unable to determine a status signal to send to the aggregator(s) 322. For example, a user may disable sharing location services for user proxy device 302(1). The detector 306 (1) may not be able to determine if the user proxy device 302(1) is home or away. Alternatively, the detector 306 (1) may be prevented from sharing whether the user proxy device 302(1) is home or away by the disabling of location services. In some examples, the detector 306 (1) can send an “unknown” signal to the aggregator(s) 322. In some examples, the aggregator(s) 322 can perform logic by ignoring or discounting an “unknown” signal from a user proxy device 302(1). In some examples, the detectors 306 can send the signals received by the detector 306 to the aggregator 322. For example, a camera accessory can send the footage of the camera of a person in the home. In some examples, the detectors 306 can include logic to determine a status based on the signals received by the detector 306. For example, a camera accessory can determine that a person is in the home and send that status signal to the aggregator 322.

The signal database 326 can include values of the status signals received from the detectors 306 of the smart devices (for example, the user proxy devices 302 and the accessories 304) as described herein. For example, the signal database 326 can store that user proxy device 302(1) is away from the home and user proxy device 302(2) is at home. Other types of signals can include that can be stored in the signal database 326 can include whether a motion sensor accessory detected movement in the home and whether network traffic on a WiFi network is relatively ambient or spiking to indicate that someone is using the network. When a home state application 320 of the controller 310 requires smart device information (e.g., state information, configuration information, feature information, smart device control information, etc.) for smart devices managed by home state application 320, home state application 320 can request the smart device information from aggregator(s) 322 and aggregator(s) 322 can obtain the information from the appropriate databases (e.g., device database 324, signal database 326, etc.) as described below.

The signal database 326 can also maintain a log of the last time a status signal was received. If an update to the status signal is not received within a time period from the last status signal, the signal database 326 can change the stored status signal to a default value. For example, if the signal database 326 has not received an update regarding whether a user proxy device 302(1) is away or at home for twenty-four hours, the signal database 326 can set the status signal corresponding to the away status of the user proxy device 302(1) to away. The time period from receiving the last status signal can be a period of time measured in seconds, minutes, hours, days, weeks, months, and the like.

In some examples, the device database 324 and the signal database 326 can be stored on the controller 310. In some examples, the device database 324 can be stored on a separate device from the controller 310 such as server 340. In some examples, the signal database 326 can be stored on a separate device from the controller 310 such as server 340. In some examples, the device database 324 and the signal database 326 can be stored in separate devices (for example, separate servers). In such examples, the controller 310 can request, transmit, and receive information from the device database 324 and/or signal database 326 through the network 308.

Home state application 320 can be configured to determine home states and manage and control settings on the smart devices. When a user installs or configures a smart device (e.g., accessory 304(1), accessory 304(2)) in the user's home, the smart device can broadcast a message (e.g., a Bluetooth signal) advertising the existence of the smart device. Home state application 320 can receive the broadcast message and add the smart device to the smart devices managed by home state application 320. For example, home state application 320 can receive information from individual smart devices (e.g., accessory 304(1), accessory 304(2), etc.) through network 308 (e.g., a WAN, LAN, WLAN, peer-to-peer Wi-Fi, Bluetooth, etc.). Home state application 320 can send commands (e.g., automatically and/or in response to user input) to change the settings of the individual smart devices through network 308. For example, home state application 320 can turn on and off smart lights, lock and unlock smart locks, turn on and off cameras, receive alarms from smoke detectors, adjust temperature through controlling HVAC systems, and manage other smart devices and appliances throughout the user's home.

In some implementations, home state application 320 can manage groups of smart devices. For example, when managing a home environment, home state application 320 can group smart devices (e.g., accessory 304(1) and accessory 304(2), etc.) according to the rooms in the house where the smart devices are located, as described above. Thus, a user can interact with home state application 320 to control all of the smart devices in a room as a group or all smart devices in a zone (across multiple rooms or parts of the home). For example, home state application 320 can determine a “room state” and/or “zone state” for the particular room and/or zone and send instructions to each smart device (e.g., accessory 304(1), accessory 304(2), etc.) in the smart device group (e.g., service group) through network 308 to change the of all of the smart devices assigned to a room and/or zone.

In some implementations, home state application 320 can group smart devices based on function, classification, or category. For example, smart devices related to external security (e.g., external lights, door locks, etc.) can be grouped together even though the smart devices are not located in the same room. In some implementations, these service groups can be generated by home state application 320 in response to user input assigning smart devices to specific groups (e.g., to rooms, to functional categories, etc.).

For example, the user can apply labels (e.g., room names, categories, etc.) to smart devices and home state application 320 can assign the smart devices to service groups based on a set of rules for processing the labels assigned to the smart devices. In some implementations, home state application 320 can automatically group smart devices according to various criteria, as described further below. In some implementations, home state application 320 can group smart devices based on a user-defined grouping. In some implementations, home state application 320 can group smart devices based on related uses. For example, home state application 320 can learn, based on historical smart device state change data, which smart devices the user typically uses together and/or what settings or states the user specifies for the smart devices and generate service groups and/or modes based on the learned user behavior, as described in detail below.

In some implementations, controller 310 can include device database 324. For example, device database 324 can include smart device configuration information for smart devices (e.g., accessory 304(1), accessory 304(2)) managed by controller 310. Home state application 320 and/or aggregator(s) 322 can, for example, obtain smart device configuration information (e.g., features, APIs, controls, commands, etc.) from accessory 304(1) when home state application 320 and/or aggregator(s) 322 connects to accessory 304(1) through network 308. For example, accessory 304(1) can send its configuration information to home state application 320 upon establishing a connection to home state application 320 and/or aggregator(s) 322 through network 308. Accessory 304(1) can send its configuration information to home state application 320 and/or aggregator(s) 322 in response to a request for configuration information from home state application 320 and/or aggregator(s) 322. When a controller 310 determines that the home state is changing to a new state, the controller 310 can query the device database 324 to determine what settings to enable on the smart devices controlled by the controller 310 and/or what instructions to transmit to the smart devices controlled by the controller 310.

In some implementations, home state application 320 and/or aggregator(s) 322 can obtain smart device configuration information from a network service (e.g., server 340) that has configuration information for accessory 304(1). For example, home state application 320 and/or aggregator(s) 322 connects to accessory 304(1), home state application 320 and/or aggregator(s) 322 can receive a smart device identifier (e.g., make, model, serial number, etc.) from accessory 304(1). Home state application 320 and/or aggregator(s) 322 can send the smart device identifier to server 340 in a request for smart device configuration information. Server 340 (e.g., a server for the smart device vendor) can obtain the configuration information associated with accessory 304(1) (e.g., from the vendor's database) based on the smart device identifier received from home state application 320 and/or aggregator(s) 322. Server 340 can send the configuration information for the identified smart device to home state application 320 and/or aggregator(s) 322 through network 308. Home state application 320 and/or aggregator(s) 322 can store the smart device configuration information in device database 324.

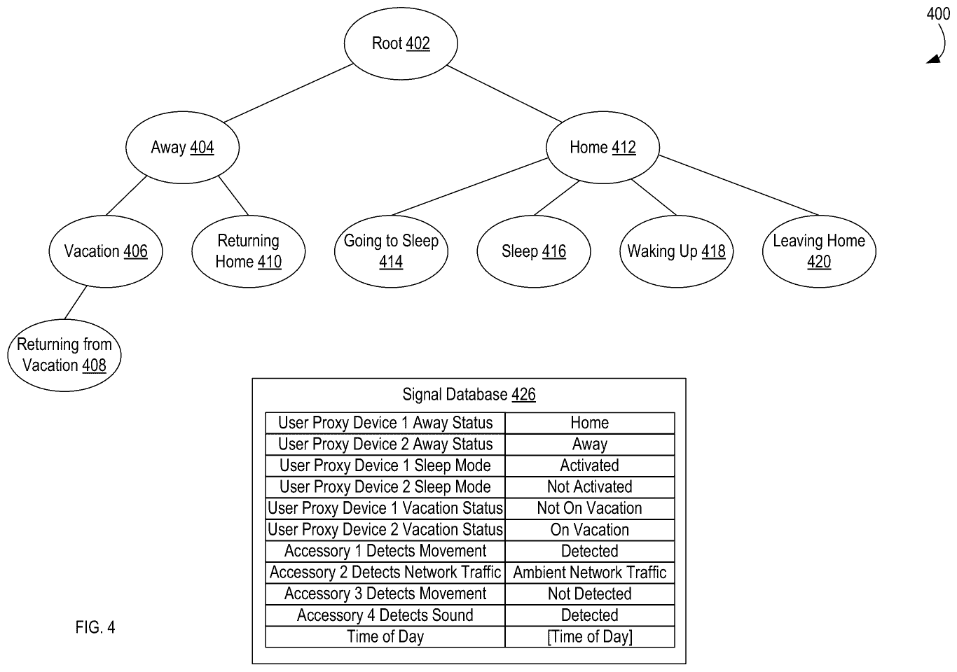

FIG. 4 includes an example hierarchy of potential states 400. The hierarchy of potential states 400 can be created by a setup device (for example, the setup device 102 of FIG. 1). The hierarchy of potential states 400 can be used to organize the home states into parent and child nodes connected by parent and child relationships. For example, as illustrated in FIG. 4, root 402 is the parent state of the “away” state 404 and the “home” state 412(also referred to as the “at-home” or “at-location” state). Similarly, the “going to sleep” state 414, the “sleep” state 416, the “waking up” state 418 and the “leaving home” state 420 are children of the “home” state 412. In some examples, characteristics describing the home and/or users associated with the home can be determined based on the home state. When a home is in a particular home state that is a child state, the home can also be said to have the characteristics of the parent state(s). For example, a home can enter a “returning home” state 410 when there is an indication that a user is returning home. When the home is in the “returning home” state 410, the characteristic that the user (or multiple users) are away from home can be true. Similarly, when the home is in an “away” state 404, the characteristics that the user (or multiple users) are away from home can be true.

Once the hierarchy of potential states 400 is created, a controller (for example, the controller 210 of FIG. 2) can determine a home state from the hierarchy of potential states 400 based on status signals from detectors (for example, detectors 306 of FIG. 3) of user proxy devices (for example, user proxy devices 202 of FIG. 2) and accessories (for example, accessories 204 of FIG. 2). For example, as illustrated in FIG. 4, the controller 210 can receive status signals from detectors on the user proxy devices and/or the accessories and store the status signals in a signal database 426. The controller can use the status signals stored in the signal database 326 to determine the home state. In some examples, the controller can determine that the home is exclusively in a single home state. For example, the home can be in an “at-home” state 412 or an “away” state 404, but not both states. Likewise, the home can be in an “at-home” state 412 or an “waking up” state 418, but not both states.

The home state can be determined at many different times. In some examples, the home state can be determined by the controller periodically after some amount of time has passed. In some examples, the home state can be determined whenever a status signal changes. In some examples, the home state can be determined whenever a threshold number of multiple status signals change.

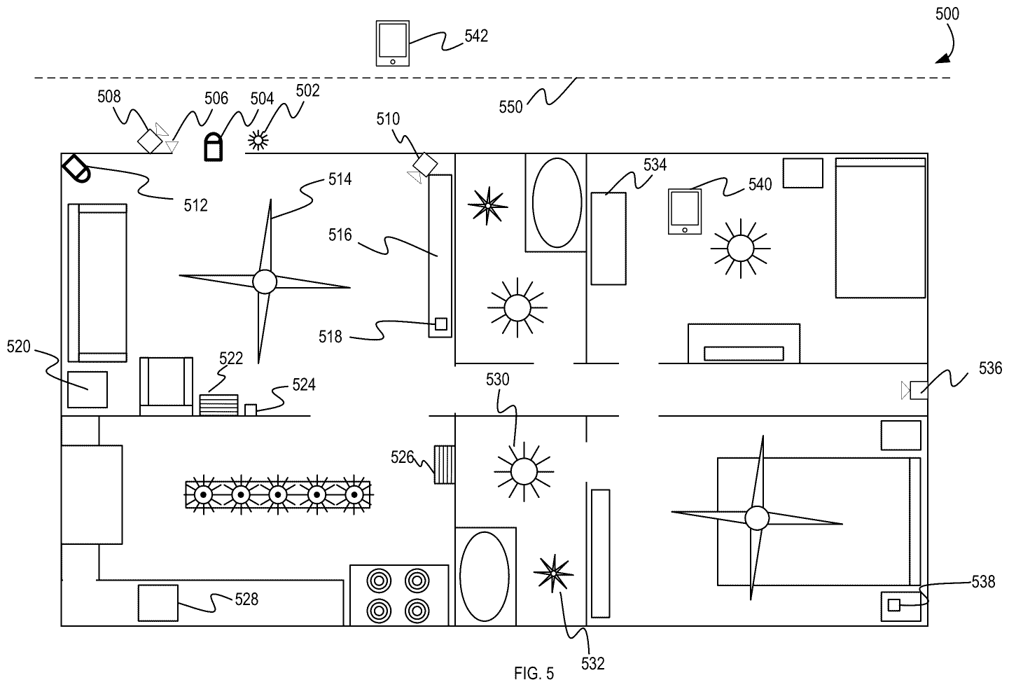

FIG. 5 is an illustration of an example home environment 500 having various smart devices 502-532. FIG. 5 can be used to illustrate example settings for example smart devices in conjunction with the home states of the hierarchy of potential states 400 of FIG. 4. While the description of the technologies described herein are described with reference to a home or residence, a person of ordinary skill in the art will understand that the features, processes, algorithms, and mechanisms implemented by these technologies can be easily applied to other contexts such as an office, a warehouse, a garage, or other building.

In some implementations, home environment 500 can be configured with smart devices 502-538. For example, smart devices 502-538 can correspond to accessories 304 of FIG. 3 and other smart devices. Smart devices 502-538 can be managed and/or controlled by home state application 320 and/or aggregator(s) 322 on controller 310, as described herein. Smart devices 502, 530 can be lights 502, 530. Smart devices 504, 512 can be motion sensors 504, 512. Smart device 506 can be a doorbell 506. Smart devices 508, 510, 536 can be cameras 508. 510, 536. For example, camera 508 can be an external camera recording footage of images outside of the home. For example, cameras 510, 536 can be internal cameras recording footage of images inside of the home. Smart devices, 514, 532 can be fans 514, 532. Smart device 516 can be a smart television 516. Smart devices 518 can be a smart streaming media device 518 (for example, a television streaming device or a smart speaker streaming audio). Smart devices 520, 528 can be lamps 520, 528. Smart devices 522, 526 can be vents 522, 526 and/or other HVAC equipment. Smart device 524 can be a thermostat 524. Smart device 534 can be an air conditioning unit 534. Smart device 538 can be a router 538 and/or network access point 538. Each type of smart device can receive different types of instructions or settings from a controller. Smart devices 516, 518, 538 can be example controllers. In some examples, each of smart devices 516, 518, 538 are controllers for the smart devices 502-538. In some examples, only one of smart devices 516, 518, 538 is a controller for the smart devices 502-538. Some or all of smart devices 502-538 can send status signals to the one or more controllers as described herein.

In some implementations, home environment 500 can interact with user proxy devices 540, 542. For example, user proxy devices 540, 542 can correspond to user proxy devices 302 of FIG. 3. Home state application 320 and/or aggregator(s) 322 on controller 310 can receive status signals from user proxy devices 540, 542 as described herein.

The root state 402 may not be an actual home state that the controller causes the home to enter. Instead, the root state 402 can represent a top-level to the hierarchy of potential states 400. In some examples, whenever a home state is determined, the controller begins determining the home state from the root state 402. In the example illustrated in FIG. 4, the controller can determine the home state starting at the root node 402. The controller can determine if the home state meets the criteria for one of the child nodes of the root node 402, namely the away state 404 or the “at-home” state 412. In other hierarchy of potential states 400, there can be multiple child nodes of the root node 402.

The away state 404 can be a state when a user is away from home. In some examples, the user can be determined to be away from home when the corresponding user proxy device is outside a geofence around the home. As shown in FIG. 5, the user proxy device 542 is beyond a geofence 550. A detector for the away status of the user corresponding to the user proxy device 542 can determine that the user is away from home because the user is outside of the geofence around the home. The detector can send the away status signal to a controller. The controller can use the away status signal of the user proxy device 542 to determine if the home should be in an away state 404. In some examples, the geofence 550 can be defined by specific coordinates such as global positioning system coordinates. In some examples, the geofence 550 can be defined as a distance from the center of the home. In some examples, the geofence 550 can be defined as a distance from the outside walls of the home.

In some examples, a home can be associated with multiple users which each have a corresponding user proxy device. In such an example, the home may only be in an away state 404 if all users are determined to be away from home. As illustrated in FIG. 5, the user proxy device 542 corresponding to a first user is beyond a geofence 550 while a user proxy device 540 corresponding to a second user is within the geofence 550. Here, the user proxy device 540 is within the geofence and thus the home may not be in an away state.

It can be advantageous to automatically enable specific settings for devices while the user(s) is away from home. For example, when all users are away from home, the cameras 508, 510, 536 and the motion sensors 504, 512 may turn on (whereas these smart devices would be off while at least one user is home). Additionally, the HVAC system (such as the air conditioner 524, the vents 522, 526, and the thermostat 524) can update settings to allow for a wider range of allowable temperatures before heating or cooling is applied to the home or rooms in the home. This can be used to conserve energy consumption while no one is home.

The vacation state 406 can be a child state of a parent state corresponding to the away state 404. The vacation state 406 can correspond to a state where the user(s) are on vacation and may be away from the home for a period of longer period of time, for example days or weeks rather than hours. In some examples, a controller may only put the home into a vacation state if all users associated with the home have indicated that they are “on vacation.” For example, each user proxy device associated with a user of the home may be in a vacation mode. In another example, a user proxy device may determine based on a calendar or other application that the user is “on vacation” or going to be away from home for an extended period of time. In some examples, all users associated with the home must be “on vacation” in order for the home to be in a vacation state 406.

Example settings for devices in the home while the home is in an on-vacation state 406 that may differ from the away state 404 can include periodically turning on lights. Another example set of settings for an on-vacation state 406 can include having an even wider range of allowable temperatures before heating or cooling is applied to the home than the range of temperatures associated with the away state 404.

As noted previously, a child state can be indicative of characteristics from the parent state. In this example, the vacation state 406 is a child state of the away state 404. This can indicate that all users associated with the home being on vacation can indicate that all users are also away.

The returning from vacation state 408 can be a child state of a parent state corresponding to the vacation state 406. A returning from vacation state 408 can correspond to a state where the user(s) are returning from vacation within a certain time period. For example, a home can enter a returning from vacation state 408 when the user(s) arrive at an airport within a threshold distance from the home. A home can also enter a returning from vacation state 408 when the user(s) come within a (relatively large) geofence area around the home if the user(s) are returning via car, bike, or other surface transport. As described herein, the user proxy devices associated with users can have detectors that contain logic to determine these kinds of conditions and can send a “returning from vacation” status signal to the controller similar to the status signals illustrated in signal database 426. The controllers can use the “returning from vacation” signal to determine whether to put the home into a returning from vacation state. In some examples, a user can set a “returning from vacation” status on their user proxy devices. Setting the status of “returning from vacation” can be sufficient for the detector to determine to send a “returning from vacation” status signal to the controller. Example settings for home devices when a home is in a returning from vacation state 408 may include changing the HVAC settings to be within a smaller range of temperatures.

The returning home state 410 can be a child state of a parent state corresponding to the away state 404. In some examples, the user can be determined to be returning home from being away from the home. For example, the user may begin their commute home from work or school. The detectors on the user proxy devices corresponding to the users may determine that a user is leaving a geofence around a commonly visited location such as work, school, or other activities. The detectors on the user proxy device may also determine that the user has been moving in a direction indicative of returning home for a sufficient amount of time. Example settings for home devices when a home is in a returning home state 410 may include changing the HVAC settings to be within a smaller range of temperatures.

The home state 412 can be state when at least one user is home. In some examples, a user can be determined to be at home when the corresponding user proxy device is within a geofence around the home. As illustrated in FIG. 5, the user proxy device 542 corresponding to a first user is beyond a geofence 550 while a user proxy device 540 corresponding to a second user is within the geofence 550. In this example, the user proxy device 540 is within the geofence and thus the home may be in a home state 412. Example settings for when a user is at home can include disabling internal cameras or playing particular media on a television or audio playback device.

In some examples, a user associated with the home may not have an associated user proxy device. In such examples, the controller may want to prevent or not put the home in an away state 404, and instead put the home in the home state 412. For example, a child may not have a smartphone or a smart watch that can act as a user proxy device for the child. Other examples of users without user proxy devices can be visitors, guests, cleaners, babysitters, and others. In an example where the child is the only user home and the other users with associated user proxy devices are determined to be away from the home, the controller may determine to put the home in the away home. However, the controller can also receive other status signals from accessories in the home such as the smart devices 502-538. For example, the motion sensor 512 and the cameras 510, 536 may detect that a person is at home. Similarly, a network access point or router 538 may detect network activity significantly above an ambient level indicating that someone is using the local network. Additionally, smart lights and lamps may be manually turned on via a switch. Other examples include the door being locked from the inside or a garage door opening. A controller can use these status signals from other accessories in the home to determine a likelihood that a user without a user proxy device is at home. In some examples, the controller can send instructions to the cameras to perform facial recognition to determine if the user without a user proxy device is a known user. In some examples, the controller can ask for the images from the cameras such that the controller can perform facial recognition to determine if the user without a user proxy device is a known user. In some examples, the controller can learn that a user without a user proxy device has a regular routine that increases the likelihood that a user without a user proxy device is in the home during certain time periods. For example, if a cleaner comes at a particular time each week, the controller can determine that the home should be in a home state 412.

In some examples, the controller can use authenticated and unauthenticated versions of states. For example, the controller may use authenticated and unauthenticated versions of the home state 412 when receiving status signals from smart devices 502-538 to determine that someone is at home. An authenticated version of a state may have different settings from an unauthenticated version of a state. For example, in an authenticated version of the home state 412, the internal cameras of the home may be turned off. However, the internal cameras of the home may not be turned off if the home is in an unauthenticated version of the home state 412. The use of an unauthenticated version of the home state 412 may allow for recording of images when a burglar or other unauthorized person is in the home unexpectantly.

When determining whether to use an authenticated or unauthenticated version of a state, the controller can have different thresholds for each version. For example, an unauthenticated version of a state may have a lower threshold of number of signals, or a lower threshold of an algorithm run on particular signals. For example, internal cameras may notice that someone is in the home, but there are no signals indicating whether the person is a known person or a person authorized to be in the home. In this example, the controller may determine to use an unauthenticated version of the home state 412. An authenticated version of a state may have a higher threshold of number of signals or particular signals may be sufficient to indicate that the controller should use an authenticated version of the state. In one example, the controller may receive a signal that someone used a code to open the garage or a door and facial recognition on the cameras/controller of images captured from internal cameras confirm that the person is a known and/or authorized person to enter the home. In this example, the controller may determine to enter an authenticated version of the home state 412. In another example, the controller may receive a signal from a user proxy device associated with a user that the user is within the geofence 550 around the home. In this example, the controller may determine to enter an authenticated version of the home state 412.

The going to sleep state 414 can be a child state of a parent state corresponding to the home state 412. A going to sleep state 414 can correspond to a state where the user(s) are preparing to go to sleep or would like to initiate settings that cause user(s) to begin to prepare to go to sleep. For example, a user may begin to turn off lights in certain parts of the home or begin certain activities that are generally performed prior to bed. In another example, at a specific time, the home may enter a going to sleep state 414. A going to sleep state 414 can include settings such as turning down lights, sounds, and the like.

The sleep state 416 can be a child state of a parent state corresponding to the home state 412. A sleep state 416 can correspond to a state where the user(s) are asleep or nearly asleep. For example, the controller can determine to enter a sleep state 416 when a user may be in bed or a signal from a user device can indicate that heart rate has dropped indicative of sleep. Example settings that may be enabled during the sleep state 416 can include maintaining a small range of temperatures in specific rooms and/or activating internal cameras.

The waking up state 418 can be a child state of a parent state corresponding to the home state 412. A waking up state 418 can correspond to a state where the user(s) are currently waking up or about to wake up based on some kind of alarm. For example, the controller may determine that the user has an alarm set to produce an alarm at a near future time. Example settings that may be enabled during a waking up state 418 can include warming up specific rooms or activating particular lights such as sunlights.

The leaving home 420 state can be a child state of a parent state corresponding to the home state 412. A leaving home state 420 can correspond to a state where the user(s) are preparing to leave the home. For example, a user may be leaving the home to go to work or school. Example settings that may be enabled during a leaving home state 420 can include deactivating HVAC or adjusting temperature ranges in order to reduce energy consumption prior to the user leaving home.

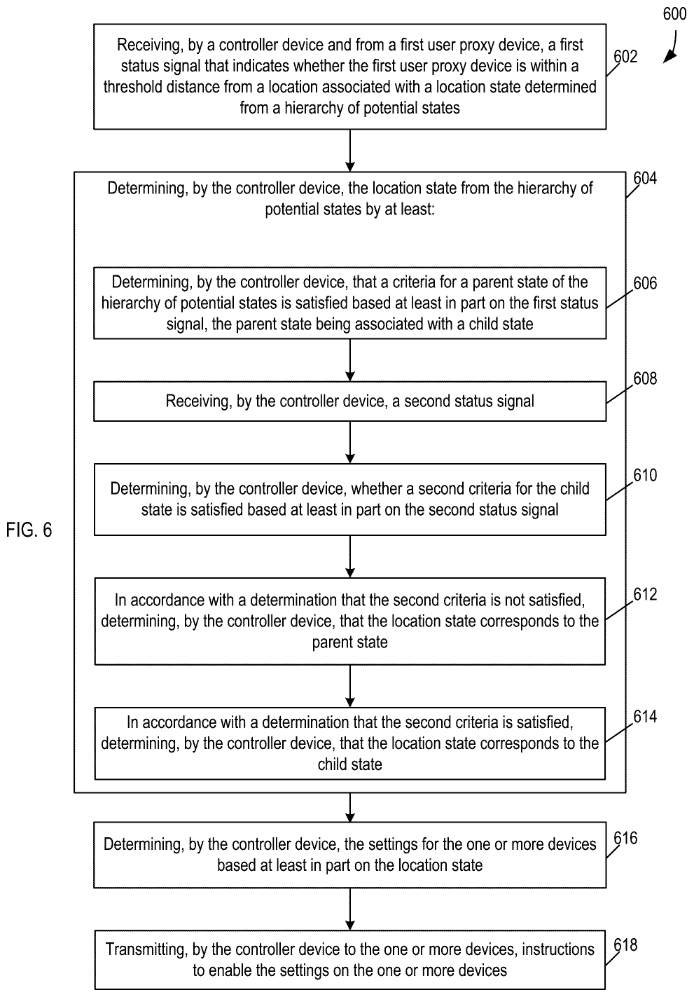

FIG. 6 illustrates an example method 600 for transmitting instructions to devices based on a state as described herein. As described herein, a home state for a home is an example a location state. Example method 600 can be implemented a controller (such as controller 210 of FIG. 2).

At block 602, a controller device (for example, a controller 210 of FIG. 2) can receive, from a first user proxy device, a first status signal that indicates whether the first user proxy device is associated with a state determined form a hierarchy of potential states.

In some examples, the first status signal that indicates whether the first user proxy device is within a threshold distance from a location associated with a state (for example, a location state) determined from a hierarchy of potential states. The location can be further associated with one or more devices including a controller device. The controller device can be configured to send instructions to the one or more devices to enable settings on the one or more devices based at least in part on the state.

At block 604, the controller device can determine the state from the hierarchy of potential states. Determining the state from the hierarchy of potential states can include the steps discussed in relation to blocks 606, 608, 610, 612, 614.

At block 606, the controller device can determine that a criteria for a parent state of the hierarchy of potential states is satisfied based at least in part on the first status signal. The parent state can be associated with a child state.

At block 608, the controller device can receive a second status signal.

At block 610, the controller device can determine whether a second criteria for the child state is satisfied based at least in part on the second status signal.

At block 612, the controller device can, in accordance with a determination that the second criteria is not satisfied, determine that the state corresponds to the parent state.

At block 614, the controller device can, in accordance with a determination that the second criteria is satisfied, determine that the state corresponds to the child state.

At block 616, the controller device can determine the settings for the one or more devices based at least in part on the state.

At block 618, the controller device can transmit, to the one or more devices, instructions to enable the settings on the one or more devices.

In some examples, the method 600 can further include the controller receiving a third status signal from a second user proxy device, the third status signal indicating whether the second user proxy device is within the threshold distance from the location. In some examples, determining that the criteria for the parent state of the hierarchy of potential states is satisfied can be further based at least in part on the third status signal. In some examples, determining that the second criteria for the child state is satisfied can be further based at least in part on the third status signal.

In some examples, the method 600 can further include the controller device receiving a third status signal from a third device of the one or more devices associated with the location, the third status signal indicating an event occurred within a second threshold distance from the location. In some examples, determining that the criteria for the parent state of the hierarchy of potential states is satisfied can be further based at least in part on the third status signal. In some examples, determining that the criteria for the parent state of the hierarchy of potential states is satisfied can further include the controller device determining that the first user proxy device is not within the threshold distance from the location based at least in part on the first status signal. In some examples, determining that the criteria for the parent state of the hierarchy of potential states is satisfied can further include the controller device determining that a person is within the threshold distance from the location based at least in part on the third status signal. In some examples, determining that the criteria for the parent state of the hierarchy of potential states is satisfied can further include the controller device determining that the criteria for the parent state is satisfied based on the person being within the threshold distance from the location. The parent state can be an at-location state (for example, an at home state) associated with any one or more persons being at the location.

In some examples, determining that the criteria for the parent state of the hierarchy of potential states is satisfied can be further based at least in part on the third status signal. Determining that the criteria for the parent state of the hierarchy of potential states is satisfied can further include the controller device determining that the first user proxy device is not within the threshold distance from the location based on the first status signal. Determining that the criteria for the parent state of the hierarchy of potential states is satisfied can further include the controller device determining whether a first threshold criteria and a second threshold criteria are satisfied based at least in part on the third status signal. Determining that the criteria for the parent state of the hierarchy of potential states is satisfied can further include, in accordance with a determination that the first threshold criteria is satisfied, and the second threshold criteria is not satisfied, the controller device determining that the criteria for an unauthenticated version of the parent state is satisfied.

Determining that the criteria for the parent state of the hierarchy of potential states is satisfied can further include, in accordance with a determination that the first threshold criteria is satisfied, and the second threshold criteria is satisfied, the controller device determining that the criteria for an authenticated version of the parent state is satisfied. Determining the settings for the one or more devices can be based further at least in part on whether the parent state is the unauthenticated version or the authenticated version.

In some examples, the second status signal can indicate that a user associated with the first user proxy device is going to sleep, and the child state being a going-to-sleep state. In some examples, the location can be one of: a building, a portion of a building, or a room of the building.

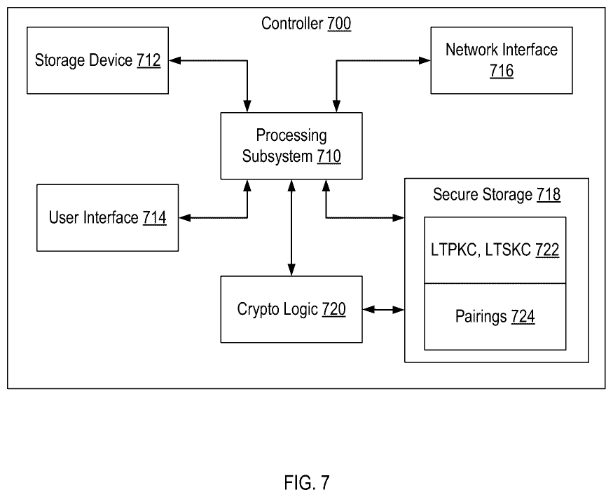

FIG. 7 shows a simplified block diagram of an example system architecture for controller 700. Controller 700 can implement any or all of the controller functions, behaviors, and capabilities described herein, as well as other functions, behaviors, and capabilities not expressly described. Controller 700 can include processing subsystem 710, storage device 712, user interface 714, communication interface 716, secure storage module 718, and cryptographic logic module 720. Controller 700 can also include other components (not explicitly shown) such as a battery, power controllers, and other components operable to provide various enhanced capabilities. In various embodiments, controller 700 can be implemented in a desktop computer, laptop computer, tablet computer, smart phone, other mobile phone, wearable computing device, resident device, smart speaker, smart television, access point, or other systems having any desired form factor. Further, as noted above, controller 700 can be implemented partly in a base station and partly in a mobile unit that communicates with the base station and provides a user interface.

Storage device 712 can be implemented, e.g., using disk, flash memory, or any other non-transitory storage medium, or a combination of media, and can include volatile and/or non-volatile media. In some embodiments, storage device 712 can store one or more application and/or operating system programs to be executed by processing subsystem 710, including programs to implement various operations described above as being performed by a controller. For example, storage device 712 can store a uniform controller application that can read an accessory description record and generate a graphical user interface for controlling the accessory based on information therein. In some embodiments, portions (or all) of the controller functionality described herein can be implemented in operating system programs rather than applications. In some embodiments, storage device 712 can also store apps designed for specific accessories or specific categories of accessories (e.g., an IP camera app to manage an IP camera accessory or a security app to interact with door lock accessories). Storage device 712 can also store other data produced or used by controller 700 in the course of its operations, including trigger data objects and/or other data pertaining to an environment model.

User interface 714 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). A user can operate input devices of user interface 714 to invoke the functionality of controller 700 and can view and/or hear output from controller 700 via output devices of user interface 714.

Processing subsystem 710 can be implemented as one or more integrated circuits, e.g., one or more single-core or multi-core microprocessors or microcontrollers, examples of which are known in the art. In operation, processing system 710 can control the operation of controller 700. In various embodiments, processing subsystem 710 can execute a variety of programs in response to program code and can maintain multiple concurrently executing programs or processes. At any given time, some or all of the program code to be executed can be resident in processing subsystem 710 and/or in storage media such as storage device 712.

Through suitable programming, processing subsystem 710 can provide various functionality for controller 700. For example, in some embodiments, processing subsystem 710 can implement various processes (or portions thereof) described above as being implemented by a controller. Processing subsystem 710 can also execute other programs to control other functions of controller 700, including application programs that may be stored in storage device 712. In some embodiments, these application programs may interact with an accessory, e.g., by generating messages to be sent to the accessory and/or receiving responses from the accessory. Such interactions can be facilitated by an accessory management daemon and/or other operating system processes, e.g., as described above.

Communication interface 716 can provide voice and/or data communication capability for controller 700. In some embodiments communication interface 716 can include radio frequency (RF) transceiver components for accessing wireless voice and/or data networks (e.g., using cellular telephone technology, data network technology such as 3G, 4G/LTE, Wi-Fi, other IEEE 802.11 family standards, or other mobile communication technologies, or any combination thereof), components for short-range wireless communication (e.g., using Bluetooth and/or Bluetooth LE standards, NFC, etc.), and/or other components. In some embodiments communication interface 716 can provide wired network connectivity (e.g., Ethernet) in addition to or instead of a wireless interface.

Communication interface 716 can be implemented using a combination of hardware (e.g., driver circuits, antennas, modulators/demodulators, encoders/decoders, and other analog and/or digital signal processing circuits) and software components. In some embodiments, communication interface 716 can support multiple communication channels concurrently or at different times, using the same transport or different transports.

Secure storage module 718 can be an integrated circuit or the like that can securely store cryptographic information for controller 700. Examples of information that can be stored within secure storage module 718 include the controller's long-term public and secret keys 722 (LTPKC, LTSKC as described above), and a list of paired accessories 724 (e.g., a lookup table that maps accessory ID to accessory long-term public key LTPKA for accessories that have completed a pair setup or pair add process as described above).

In some embodiments, cryptographic operations can be implemented in a cryptographic logic module 720 that communicates with secure storage module 718. Physically, cryptographic logic module 720 can be implemented in the same integrated circuit with secure storage module 718 or a different integrated circuit (e.g., a processor in processing subsystem 710) as desired. Cryptographic logic module 720 can include various logic circuits (fixed or programmable as desired) that implement or support cryptographic operations of controller 700, including any or all cryptographic operations described above. Secure storage module 718 and/or cryptographic logic module 720 can appear as a “black box” to the rest of controller 700. Thus, for instance, communication interface 716 can receive a message in encrypted form that it cannot decrypt and can simply deliver the message to processing subsystem 710. Processing subsystem 710 may also be unable to decrypt the message, but it can recognize the message as encrypted and deliver it to cryptographic logic module 720. Cryptographic logic module 720 can decrypt the message (e.g., using information extracted from secure storage module 718) and determine what information to return to processing subsystem 710. As a result, certain information can be available only within secure storage module 718 and cryptographic logic module 720. If secure storage module 718 and cryptographic logic module 720 are implemented on a single integrated circuit that executes code only from an internal secure repository, this can make extraction of the information extremely difficult, which can provide a high degree of security. Other implementations are also possible.

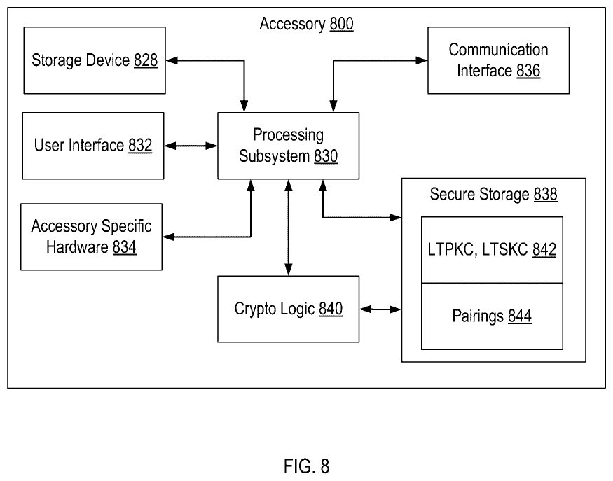

FIG. 8 shows a simplified block diagram of an example system architecture for accessory 800. Accessory 800 can implement any or all of the accessory functions, behaviors, and capabilities described herein, as well as other functions, behaviors, and capabilities not expressly described. Accessory 800 can include storage device 828, processing subsystem 830, user interface 832, accessory-specific hardware 834, communication interface 836, secure storage module 838, and cryptographic logic module 840. Accessory 800 can also include other components (not explicitly shown) such as a battery, power controllers, and other components operable to provide various enhanced capabilities.

Accessory 800 is representative of a broad class of accessories that can be operated by a controller such as controller 700, and such accessories can vary widely in capability, complexity, and form factor. Various accessories may include components not explicitly shown in FIG. 8, including but not limited to storage devices (disk, flash memory, etc.) with fixed or removable storage media; video screens, speakers, or ports for connecting to external audio/video devices; camera components such as lenses, image sensors, and controls for same (e.g., aperture, zoom, exposure time, frame rate, etc.); microphones for recording audio (either alone or in connection with video recording); and so on.

Storage device 828 can be implemented, e.g., using disk, flash memory, or any other non-transitory storage medium, or a combination of media, and can include volatile and/or non-volatile media. In some embodiments, storage device 828 can store one or more programs (e.g., firmware) to be executed by processing subsystem 830, including programs to implement various operations described above as being performed by an accessory, as well as operations related to particular accessory behaviors. Storage device 828 can also store an accessory object or accessory definition record that can be furnished to controller devices, e.g., during device discovery. Storage device 828 can also store accessory state information and any other data that may be used during operation of accessory 800.

Processing subsystem 830 can include, e.g., one or more single-core or multi-core microprocessors and/or microcontrollers executing program code to perform various functions associated with accessory 800. For example, processing subsystem 830 can implement various processes (or portions thereof) described above as being implemented by an accessory, e.g., by executing program code stored in storage device 828. Processing subsystem 830 can also execute other programs to control other functions of accessory 830. In some instances, programs executed by processing subsystem 830 can interact with a controller (e.g., controller 700), e.g., by generating messages to be sent to the controller and/or receiving messages from the controller.

User interface 832 may include user-operable input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). Depending on the implementation of a particular accessory 800, a user can operate input devices of user interface 832 to invoke functionality of accessory 800 and can view and/or hear output from accessory 800 via output devices of user interface 832. Some accessories may provide a minimal user interface or no user interface. at all. Where the accessory does not have a user interface, a user can still interact with the accessory using a controller (e.g., controller 700).

Accessory-specific hardware 834 can include any other components that may be present in accessory 800 to enable its functionality. For example, in various embodiments accessory-specific hardware 834 can include one or more storage devices using fixed or removable storage media; GPS receiver; power supply and/or power management circuitry; a camera; a microphone; one or more actuators; control switches; environmental sensors (e.g., temperature sensor, pressure sensor, accelerometer, chemical sensor, etc.); and so on. It is to be understood that any type of accessory functionality can be supported by providing appropriate accessory-specific hardware 834 and that accessory-specific hardware can include mechanical as well as electrical or electronic components.

Communication interface 836 can provide voice and/or data communication capability for accessory 800. In some embodiments communication interface 836 can include radio frequency (RF) transceiver components for accessing wireless voice and/or data networks (e.g., using cellular telephone technology, data network technology such as 3G, 4G/LTE, Wi-Fi, other IEEE 802.11 family standards, or other mobile communication technologies, or any combination thereof), components for short-range wireless communication (e.g., using Bluetooth and/or Bluetooth LE standards, NFC, etc.), and/or other components. In some embodiments communication interface 836 can provide wired network connectivity (e.g., Ethernet) in addition to or instead of a wireless interface. Communication interface 836 can be implemented using a combination of hardware (e.g., driver circuits, antennas, modulators/demodulators, encoders/decoders, and other analog and/or digital signal processing circuits) and software components. In some embodiments, communication interface 836 can support multiple communication channels concurrently or at different times, using the same transport or different transports.

Secure storage module 838 can be an integrated circuit or the like that can securely store cryptographic information for accessory 800. Examples of information that can be stored within secure storage module 838 include the accessory's long-term public and secret keys 842 (LTPKA, LTSKA as described above), and a list of paired controllers 844(e.g., a lookup table that maps controller ID to controller long-term public key LTPKC for controllers that have completed a pair setup or pair add process as described above). In some embodiments, secure storage module 838 can be omitted; keys and lists of paired controllers can be stored in storage device 828.

In some embodiments, cryptographic operations can be implemented in a cryptographic logic module 840 that communicates with secure storage module 838. Physically, cryptographic logic module 840 can be implemented in the same integrated circuit with secure storage module 838 or a different integrated circuit (e.g., a processor in processing subsystem 830) as desired. Cryptographic logic module 840 can include various logic circuits (fixed or programmable as desired) that implement or support cryptographic operations of accessory 800, including any or all cryptographic operations described above. Secure storage module 838 and/or cryptographic logic module 840 can appear as a “black box” to the rest of accessory 800. Thus, for instance, communication interface 836 can receive a message in encrypted form that it cannot decrypt and can simply deliver the message to processing subsystem 830. Processing subsystem 830 may also be unable to decrypt the message, but it can recognize the message as encrypted and deliver it to cryptographic logic module 840. Cryptographic logic module 840 can decrypt the message (e.g., using information extracted from secure storage module 838) and determine what information to return to processing subsystem 830. As a result, certain information can be available only within secure storage module 838 and cryptographic logic module 840. If secure storage module 838 and cryptographic logic module 840 are implemented on a single integrated circuit that executes code only from an internal secure repository, this can make extraction of the information extremely difficult, which can provide a high degree of security. Other implementations are also possible.

Accessory 800 can be any electronic apparatus that interacts with controller 700. In some embodiments, controller 700 can provide remote control over operations of accessory 800 as described above. For example, controller 700 can provide a remote user interface for accessory 800 that can include both input and output controls (e.g., a display screen to display current status information obtained from accessory 800 and an input control such as a touchscreen overlay to allow changes to the status information). Controller 700 in various embodiments can control any function of accessory 800 and can also receive data from accessory 800.

It will be appreciated that the system configurations and components described herein are illustrative and that variations and modifications are possible. It is to be understood that an implementation of controller 700 can perform all operations described above as being performed by a controller and that an implementation of accessory 800 can perform any or all operations described above as being performed by an accessory. A proxy, bridge, tunnel, or coordinator can combine components of controller 700 and accessory 800, using the same hardware or different hardware as desired. The controller and/or accessory may have other capabilities not specifically described herein (e.g., mobile phone, global positioning system (GPS), broadband data communication, Internet connectivity, etc.). Depending on implementation, the devices can interoperate to provide any functionality supported by either (or both) devices or to provide functionality that is partly implemented in each device. In some embodiments, a particular accessory can have some functionality that is not accessible or invocable via a particular controller but is accessible via another controller or by interacting directly with the accessory.

Further, while the controller and accessory are described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present technologies described herein can be realized in a variety of apparatus including electronic devices implemented using any combination of circuitry and software.

While the technologies described herein have been described with respect to specific embodiments, one skilled in the art will recognize that numerous modifications are possible. Controller networks and/or accessory networks can include as many or as few devices as desired. Use of a proxy or coordinator is not required; regardless of the number of accessories or number of controllers, it is always possible (at least in principle) to establish pairings between each controller and each accessory and to have all controllers operate by controlling accessories directly. Where an accessory-network model (e.g., an environment model) is provided, each controller can obtain a copy of the model (e.g., via synchronization) and can provide access to the model through its user interface.

Further, where proxies or controllers are present, it can be but need not be the case that all controllers are permitted to access all accessories via the proxy or controller. Some controllers might be restricted from accessing accessories when not within the local environment, and some accessories might require that controllers access them directly rather than through a proxy or coordinator.

Embodiments of the present technologies described herein can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present technologies described herein may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the technologies described herein have been described with respect to specific embodiments, it will be appreciated that the disclosure is intended to cover all modifications and equivalents within the scope of the following claims.

What is claimed is:

1. A method comprising:
receiving, by a controller device and from a first user proxy device, a first status signal that indicates whether the first user proxy device is associated with a state determined from a hierarchy of potential states, the controller device being configured to send instructions to one or more devices associated with the controller device to enable settings on the one or more devices based at least in part on the state;
determining, by the controller device, the state from the hierarchy of potential states by at least:
determining, by the controller device, that a criteria for a parent state of the hierarchy of potential states is satisfied based at least in part on the first status signal, the parent state being associated with a child state;
receiving, by the controller device, a second status signal;
determining, by the controller device, whether a second criteria for the child state is satisfied based at least in part on the second status signal;
in accordance with a determination that the second criteria is not satisfied, determining, by the controller device, that the state corresponds to the parent state; and
in accordance with a determination that the second criteria is satisfied, determining, by the controller device, that the state corresponds to the child state; and
determining, by the controller device, the settings for the one or more devices based at least in part on the state; and
transmitting, by the controller device to the one or more devices, instructions to enable the settings on the one or more devices.

2. The method of claim 1, wherein the second status signal indicates whether the first user proxy device is within a threshold distance from a location.

3. The method of claim 2, further comprising receiving, by the controller device, a third status signal from a third device of the one or more devices associated with the location, the third status signal indicating an event occurred within a second threshold distance from the location.

4. The method of claim 3, wherein determining that the criteria for the parent state of the hierarchy of potential states is satisfied is further based at least in part on the third status signal, wherein determining that the criteria for the parent state of the hierarchy of potential states is satisfied further includes:
determining, by the controller device, that the first user proxy device is not within the threshold distance from the location based at least in part on the second status signal;
determining, by the controller device, that a person is within the threshold distance from the location based at least in part on the third status signal; and
determining, by the controller device, that the criteria for the parent state is satisfied based on the person being within the threshold distance from the location, the parent state being an at-location state associated with any one or more persons being at the location.

5. The method of claim 3, wherein determining that the criteria for the parent state of the hierarchy of potential states is satisfied is further based at least in part on the third status signal, wherein determining that the criteria for the parent state of the hierarchy of potential states is satisfied further includes:
determining, by the controller device, that the first user proxy device is not within the threshold distance from the location based on the second status signal;
determining, by the controller device, whether a first threshold criteria and a second threshold criteria are satisfied based at least in part on the third status signal; and
in accordance with a determination that the first threshold criteria is satisfied and the second threshold criteria is not satisfied, determining, by the controller device, that the criteria for an unauthenticated version of the parent state is satisfied; and
in accordance with a determination that the first threshold criteria is satisfied and the second threshold criteria is satisfied, determining, by the controller device, that the criteria for an authenticated version of the parent state is satisfied,
wherein determining the settings for the one or more devices is based further at least in part on whether the parent state is the unauthenticated version or the authenticated version.

6. The method of claim 3, wherein determining that the criteria for the parent state of the hierarchy of potential states is satisfied is further based at least in part on the third status signal.

7. The method of claim 3, wherein determining that the second criteria for the child state is satisfied is further based at least in part on the third status signal.

8. The method of claim 3, wherein the third status signal is an indication of either movement in or around the location, or recognition of a face of a person.

9. A controller device, comprising:
a memory configured to store computer-executable instructions; and
one or more processors in communication with the memory and configured to access the memory and execute the computer-executable instructions to:
receive, from a first user proxy device, a first status signal that indicates whether the first user proxy device is associated with a state determined from a hierarchy of potential states, the controller device being configured to send instructions to one or more devices associated with the controller device to enable settings on the one or more devices based at least in part on the state;
determine the state from the hierarchy of potential states by at least:
determine that a criteria for a parent state of the hierarchy of potential states is satisfied based at least in part on the first status signal, the parent state being associated with a child state;
receive a second status signal;
determine whether a second criteria for the child state is satisfied based at least in part on the second status signal;
in accordance with a determination that the second criteria is not satisfied, determine that the state corresponds to the parent state; and
in accordance with a determination that the second criteria is satisfied, determine that the state corresponds to the child state; and
determine the settings for the one or more devices based at least in part on the state; and
transmit, to the one or more devices, instructions to enable the settings on the one or more devices.

10. The controller device of claim 9, wherein the second status signal indicates whether the first user proxy device is within a threshold distance from a location.

11. The controller device of claim 10, wherein the one or more processors is further configured to access the memory and execute the computer-executable instructions to receive a third status signal from a second user proxy device, the third status signal indicating whether the second user proxy device is within the threshold distance from the location.

12. The controller device of claim 11, wherein determining that the criteria for the parent state of the hierarchy of potential states is satisfied is further based at least in part on the third status signal.

13. The controller device of claim 12, wherein determining that the second criteria for the child state is satisfied is further based at least in part on the third status signal.

14. A non-transitory computer-readable storage medium having stored thereon program instructions that, when executed by one or more processors of a controller device, cause the controller device to perform operations comprising:
receiving, from a first user proxy device, a first status signal that indicates whether the first user proxy device is associated with a state determined from a hierarchy of potential states, the controller device being configured to send instructions to one or more devices associated with the controller device to enable settings on the one or more devices based at least in part on the state;
determining the state from the hierarchy of potential states by at least:
determining that a criteria for a parent state of the hierarchy of potential states is satisfied based at least in part on the first status signal, the parent state being associated with a child state;
receiving a second status signal;
determining whether a second criteria for the child state is satisfied based at least in part on the second status signal;
in accordance with a determination that the second criteria is not satisfied, determining that the state corresponds to the parent state; and
in accordance with a determination that the second criteria is satisfied, determining that the state corresponds to the child state; and
determining the settings for the one or more devices based at least in part on the state; and
transmitting, to the one or more devices, instructions to enable the settings on the one or more devices.

15. The non-transitory computer-readable storage medium of claim 14, wherein the second status signal indicates whether the first user proxy device is within a threshold distance from a location.

16. The non-transitory computer-readable storage medium of claim 15, wherein the operations further comprise receiving a third status signal from the first user proxy device, the third status signal indicating that a user associated with the first user proxy device is intending to go to the location.

17. The non-transitory computer-readable storage medium of claim 16, wherein determining that the second criteria for the child state is satisfied is further based at least in part on the third status signal.

18. The non-transitory computer-readable storage medium of claim 15, wherein the location is one of: a building, a portion of a building, or a room of the building.

19. The non-transitory computer-readable storage medium of claim 14, wherein the second criteria are satisfied, the child state being a transition state associated with a transition criteria and a timer, and wherein the operations further comprise:
determining whether the transition criteria is satisfied prior to an expiration of the timer;
in accordance with a determination that the transition criteria is not satisfied prior to the expiration of the timer, determining the state is a second child state of the parent state; and
in accordance with a determination that the transition criteria is not satisfied prior to the expiration of the timer, determining the state is the parent state.

20. The non-transitory computer-readable storage medium of claim 14, wherein the second status signal indicates that a user associated with the first user proxy device is going to sleep, and the child state being a going-to-sleep state.
